(19) United States
(12) Patent Application Publication
(10) Pub. No.: US 2010/0307708 A1
(43) Pub. Date: Dec. 9, 2010

(54) METHOD FOR MANUFACTURING SUPPORT FOR PLANOGRAPHIC PRINTING PLATE AND METHOD FOR RECYCLING PLANOGRAPHIC PRINTING PLATE

(75) Inventors: Yoshio OOKISHI, Haibara-gun (JP); Naoki Yoshikawa, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/795,305

(22) Filed: Jun. 7, 2010

(30) Foreign Application Priority Data
Jun. 8, 2009 (JP) 2009-136941

(51) Int. Cl. B22D 25/00; B22D 23/00; B41N 6/00

(52) U.S. Cl. 164/4.1; 101/401.1

(57) ABSTRACT

Unlike related art in which a variety of recycling aluminum materials are directly inputted into a pre-rolling melting furnace, the present invention provides the step of melting used planographic printing plates roughened by hydrochloric acid-based electrolysis in another melting furnace into a recycled metal ingot having a predetermined shape and weight and the step of using the results obtained by analyzing the recycled metal ingot to determine the mix proportions of the recycled metal ingot, the fresh metal ingot, and the trace metal master alloy to be inputted into the pre-rolling melting furnace. As a result, the amount of CO₂ produced at the time of manufacture can be greatly reduced, and an aluminum plate having an aluminum purity of 99.0% or higher, which is required in a hydrochloric acid-based electrolytic roughening, can be manufactured.

### BACKGROUND OF THE INVENTION

1. Field of the Invention

The present invention relates to a method for manufacturing a support for a planographic printing plate and a method for recycling a planographic printing plate, and particularly to a technology for recycling and reusing a used planographic printing plate to reduce the amount of CO₂ produced when a planographic printing plate is manufactured.

2. Description of the Related Art

Reduction in the amount of produced CO₂, which contributes to the global warming, is currently addressed worldwide, and so is in the lithographic printing plate manufacturing industry.

A planographic printing plate is manufactured by forming a plate making layer (photosensitive layer, for example) on a roughened, aluminum support for a planographic printing plate. Exemplary roughening methods include mechanical roughening, electrochemical roughening, chemical roughening (chemical etching), and combinations thereof. Examples of the electrochemical roughening include a method in which an AC current is conducted through an aluminum plate in a hydrochloric acid solution and a method in which an AC current is conducted through an aluminum plate in a nitric acid solution.

The surface of a support for a planographic printing plate needs to be uniformly and densely roughened so that satisfactory adhesion to the plate making layer is achieved. To this end, the support for a planographic printing plate needs to be made of a highly pure fresh metal ingot with trace metals, such as Si, Fe, Cu, and Mn, the contents of which precisely adjusted.

It therefore has been difficult to use used planographic printing plates (aluminum scrap) as a raw material for recycling a support for a planographic printing plate, and such used planographic printing plates are in reality recycled into recycling materials for applications in which a high metal content is accepted, such as materials for recycled window sashes, automobile engines, and automobile wheels around which tires are attached.

However, the fact that a large amount of energy, as large as 140.9 MJ, is required to manufacture 1 kg of fresh metal ingot leads to production of a significantly large amount of CO₂, 9.22 kg per 1 kg of metal ingot, which contributes to the global warming. On the other hand, when used planographic printing plates having been used in printing, and cut pieces and other leftovers from a planographic printing plate left in the course of manufacturing the planographic printing plate are used as a raw material of a recycled metal ingot, the energy used to manufacture 1 kg of recycled metal ingot is approximately 4% of the energy required when a fresh metal ingot is used, and the amount of produced CO₂ is also significantly small, approximately 4% of the amount of CO₂ produced when a fresh metal ingot is used.

To reduce the amount of produced CO₂, it is therefore important to recycle used planographic printing plates, cut pieces, and other leftovers into a recycling material. To this end, it is important to establish a recycling method for not only reducing the amount of CO₂ emission but also ensuring the quality of a support for a planographic printing plate.

Methods for recycling used planographic printing plates and leftovers described above into a recycling material have been studied in recent years and, for example, described in Japanese Patent Application Laid-Open Nos. 2008-201038, 2008-114404, 2002-331767, and 2002-225449.

Japanese Patent Application Laid-Open No. 2008-201038 describes a planographic printing plate support roughening method in which an aluminum plate is electrochemically roughened by using an AC current in a nitric acid solution. Specifically, the nitric acid solution contains 7 to 20 g of nitric acid per liter, 4 to 10 g of aluminum ion per liter, and 25 to 130 mg of Mn per liter. Japanese Patent Application Laid-Open No. 2008-201038 states that the roughening method allows the surface of a support for a planographic printing plate to be roughened and have preferred surface roughness even when a fresh aluminum ingot, used planographic printing plates, and other materials are used as a recycling material.

Japanese Patent Application Laid-Open No. 2008-114404 describes a method for manufacturing a support for a planographic printing plate by preparing an aluminum plate containing manganese and magnesium the total content of which ranges from 0.05 to 1.5% by mass, using at least a brush and a slurry liquid containing an abrasive to perform mechanical roughening on the aluminum plate so that the surface thereof is roughened and the average surface roughness Ra ranges from 0.30 to 0.43 μm, and further performing electrochemical roughening and chemical etching in this order so that not only is the average surface roughness Ra increased by a value ranging from 0.10 to 0.20 μm from the average surface roughness Ra after the mechanical roughening but also the final average surface roughness Ra ranges from 0.42 to 0.60 μm. Japanese Patent Application Laid-Open No. 2008-114404 states that the roughening method allows a support for a planographic printing plate excellent in resistance to printing and dirt to be produced even when a fresh metal ingot, used planographic printing plates, and other materials are used as a recycling material.

Japanese Patent Application Laid-Open No. 2002-331767 describes a method for reducing the cost of manufacturing a support for a planographic printing plate by recycling used aluminum cans into a raw material for manufacturing a low-purity aluminum support for a planographic printing plate.

Japanese Patent Application Laid-Open No. 2002-225449 describes a method for manufacturing a support for a planographic printing plate, the method including the steps of inputting used planographic printing plates into molten aluminum and dissolving them therein, the proportion of the used planographic printing plates being 1 to 90% of the molten aluminum by mass, producing an aluminum alloy plate from the molten aluminum with the used planographic printing plates dissolved therein, and performing roughening including electrochemical roughening on the aluminum alloy plate to produce a support for a planographic printing plate. In the method, b/a≦0.3 is satisfied, where “a” represents the mass of A1000 aluminum contained in the used planographic printing plates and “b” represents the mass of A3000 aluminum contained in the used planographic printing plates. The Japanese Patent Application Laid-Open No. 2002-225449 states that the manufacturing method allows a support for a planographic printing plate to be produced without any practical problem by recycling used planographic printing plates into a recycling material without any precise raw material management.

### SUMMARY OF THE INVENTION

Japanese Patent Application Laid-Open Nos. 2008-201038 and 2008-114404 describe roughening technologies for recycling used planographic printing plates. Japanese Patent Application Laid-Open No. 2002-331767 is a technology for reusing used aluminum cans as a material for recycling a support for a planographic printing plate. In Japanese Patent Application Laid-Open No. 2002-225449, the type and mix proportion of each aluminum alloy contained in used planographic printing plates are well considered. Any of the technologies described above is a method in which used aluminum materials are directly inputted into a pre-rolling melting furnace. It is therefore inevitable that the composition of the used aluminum to be inputted greatly affects the alloy composition of a rolled aluminum plate.

When a planographic printing plate is roughened by electrolysis, in particular, hydrochloric acid-based electrolysis, the alloy composition of the aluminum plate decisively affects the quality of the roughness.

Therefore, to produce an aluminum plate having an aluminum purity of 99.0% or higher, which is necessary in hydrochloric acid-based electrolysis, none of the methods described in Japanese Patent Application Laid-Open Nos. 2008-201038, 2008-114404, 2002-331767, and 2002-225449 are appropriate because they cannot determine in advance a maximum acceptable amount of used planographic printing plate made of a variety of aluminum materials and inputted into a pre-rolling melting furnace, and a smaller amount is inputted to assure the quality of the resultant product.

On the other hand, to increase the amount of used planographic printing plate to be inputted, it is necessary to repeat measuring the impurity composition of the used planographic printing plates before inputting them into the pre-rolling melting furnace, resulting in an increased period required for melting and component adjusting processes and hence a reduced yield due to produced oxidized materials (aluminum oxides). As a result, reduction in the amount of produced CO2, which is quite important in recycling technologies, is not achieved.

The present invention has been made in view of the circumstances described above. An object of the present invention is to provide a method for manufacturing a support for a planographic printing plate and a method for recycling a planographic printing plate that allow significant reduction in the amount of produced CO2, which contributes to the global warming.

To achieve the object described above, an aspect of the present invention provides a method for manufacturing a support for a planographic printing plate, the method including a preparation step of preparing used planographic printing plates, as a recycling material, roughened by hydrochloric acid-based electrolysis, a recycled metal ingot manufacturing step of manufacturing a recycled metal ingot by melting the recycling material in a melting furnace into molten metal and molding the molten metal into a recycled metal ingot having a predetermined shape and weight, an analysis step of analyzing an aluminum purity and trace metal contents of the recycled metal ingot, a comparison step of comparing the analyzed values with a desired aluminum purity and desired trace metal contents of a predetermined planographic printing plate and calculating the difference, a mix ratio determination step of determining a mix ratio, based on the calculated difference, of a fresh metal ingot having a fixed aluminum purity and fixed trace metal contents and a trace metal master alloy having fixed trace metal contents to the recycled metal ingot, a heating and melting step of inputting the recycled metal ingot, the fresh metal ingot, and the trace metal master alloy into a pre-rolling melting furnace in accordance with the determined mix ratio and heating and melting the recycled metal ingot, the fresh metal ingot, and the trace metal master alloy into molten aluminum, and a support formation step of forming a support for a planographic printing plate, which is a strip-shaped aluminum plate, from the resultant molten aluminum in a rolling process.

The recycling material preferably includes cut pieces and other leftovers from a planographic printing plate left in the course of a planographic printing plate manufacturing process as well as the used planographic printing plates having been used in printing. The predetermined planographic printing plate used herein means that its required aluminum purity and trace metal contents are predetermined in accordance with the type of planographic printing plate to be manufactured. “The fresh metal ingot having a fixed aluminum purity and fixed trace metal contents” and “the trace metal master alloy having fixed trace metal contents” used herein refer to “a fresh metal ingot which has a known aluminum purity and a known trace metal contents” and “a trace metal master alloy which has known trace metal contents”.

In the present invention, since a used planographic printing plate roughened by hydrochloric acid-based electrolysis is melted in the melting furnace in the recycled metal ingot manufacturing step faster than a planographic printing plate roughened by mechanical roughening or nitric acid-based electrolysis, and hence the tact time required to produce a recycled metal ingot can be shortened, the amount of oxidized substances (aluminum oxides) produced when the aluminum comes into contact with air in the melting process is reduced. As a result, the yield of the recycled metal ingot increases, whereby the amount of CO₂ produced when 1 kg of recycled metal ingot is manufactured can be reduced.

The aluminum purity and the trace metal contents of a used planographic printing plate vary within certain ranges, and in particular, the amounts of trace metals may increase due to a printing ink used along with the planographic printing plate and other factors. Further, the aluminum purity and the trace metal contents of a fresh metal ingot itself vary within certain ranges. On the other hand, the aluminum purity and the trace metal contents required for a support for a planographic printing plate differ depending on the type of planographic printing plate to be manufactured.

In consideration of the fact described above, in the present invention, the aluminum purity and the trace metal contents of a recycled metal ingot are analyzed. The analyzed values are compared with a desired aluminum purity and desired trace metal contents of a predetermined planographic printing plate, and the difference therebetween is calculated. Based on the calculated difference, the mix ratio of a fresh metal ingot having a fixed aluminum purity and fixed trace metal contents and a trace metal master alloy having fixed trace metal contents to the recycled metal ingot is determined. As a result, the proportion of the recycled metal ingot to be mixed can be maximized.

That is, unlike related art in which a variety of recycling aluminum materials are directly inputted into a pre-rolling melting furnace, the present invention provides the step of melting used planographic printing plates roughened by hydrochloric acid-based electrolysis in another melting furnace into a recycled metal ingot having a predetermined shape and weight and the step of using the results obtained by analyzing the recycled metal ingot to determine the mix proportions of the recycled metal ingot, the fresh metal ingot, and the trace metal master alloy to be inputted into the pre-rolling melting furnace. As a result, the amount of CO₂ produced at the time of manufacture can be greatly reduced, and an aluminum plate having an aluminum purity of 99.0% or higher, which is required in a hydrochloric acid-based electrolytic roughening, can be manufactured.

As a result, the amount of used planographic printing plates for reuse can be maximized and the amount of fresh metal ingot to be used can be minimized, whereby the amount of CO₂ produced when planographic printing plates are manufactured can be significantly reduced.

Therefore, the CO₂ reduction resulting from the yield improvement and the CO₂ reduction resulting from the maximized mix proportion of used planographic printing plates allow the amount of CO₂ produced when a support for a planographic printing plate of the present invention is manufactured to be reduced by approximately 75%, as compared with the amount of CO₂ produced when a support for a planographic printing plate is manufactured by using only a fresh metal ingot.

When the recycling material contains planographic printing plates roughened by using methods other than hydrochloric acid-based electrolysis, it is preferable to provide a sorting step before the recycled metal ingot manufacturing step. In the sorting step, only used planographic printing plates roughened by hydrochloric acid-based electrolysis are sorted out from the others.

In the method for manufacturing a support for a planographic printing plate according to the present invention, the recycling material is preferably melted at a temperature within a range from 680 to 750° C. in the recycled metal ingot manufacturing step. Setting the temperature at 680° C. or higher allows the melting period to be shorter than that when the temperature is lower than 680° C., and setting the temperature at 750° C. or lower allows the yield to be higher than that when the temperature is higher than 750° C.

In the method for manufacturing a support for a planographic printing plate according to the present invention, the aluminum purity of the molten aluminum before the rolling process is preferably 99.0% or higher, more preferably 99.5% or higher.

The reason for this is that an aluminum plate having an aluminum purity of 99.0% or higher is preferably used in a hydrochloric acid-based electrolytic roughening. Another reason for this is that breaking and other problems tend to occur during the rolling process, in which the aluminum plate is rolled, when the aluminum purity is lower than 99.0%.

In the method for manufacturing a support for a planographic printing plate according to the present invention, the recycled metal ingot is preferably shaped into a trapezoidal block and weighs from 10 to 1200 kg per block, and the recycled metal ingot is preferably inputted into the pre-rolling melting furnace in such a way that a bottom surface of the trapezoidal block is placed on the floor of the pre-rolling melting furnace.

When the recycled metal ingot has a spherical shape and is inputted into the pre-rolling melting furnace, the load is concentrated at a single point on the surface of the bottom wall of the pre-rolling melting furnace. In this case, the surface of the bottom wall is likely damaged unless the weight of the recycled metal ingot is smaller than 500 kg. Since the material of a typical melting furnace contains Si, the surface of the bottom wall damaged when the recycled metal ingot is inputted releases Si through the damaged portion, and not only does the dissolved Si contaminates the recycled metal ingot but also the melting furnace may be broken in the worst case. Further, the spherical recycled metal ingots are inevitably laid flat, resulting in an increased storage space.

In contrast, when the recycled metal ingot has a trapezoidal shape and is inputted into the melting furnace, the load, which is a surface load, is distributed over the surface of the bottom wall of the melting furnace. In this case, the recycled metal ingot will not damage or break the surface of the bottom wall of the melting furnace even when the recycled metal ingot weighs up to 1200 kg. The trapezoidal shape used herein refers to a shape obtained by truncating a quadrangular pyramid or any other similar pyramidal shape placed with the apex thereof oriented downward and removing a lower portion thereof, and the truncated surface corresponds to the bottom surface.

As a result, the recycled metal ingot will not be contaminated with Si, and the recycled metal ingot can be more efficiently inputted into the melting furnace, whereby the work efficiency in the recycled metal ingot manufacturing process is improved. Further, since the trapezoidal recycled metal ingot allows stacked storage, the storage space can be reduced.

In the method for manufacturing a support for a planographic printing plate according to the present invention, the trace metals to be analyzed preferably include at least Si, Fe, Cu, and Mn. The reason for this is that the trace metals described above greatly affect the quality of hydrochloric acid-based electrolytic roughening.

To achieve the object described above, another aspect of the present invention provides a method for recycling a planographic printing plate, the method including a roughening step of the steps of performing hydrochloric acid-based electrolytic roughening on at least one side of the support for a planographic printing plate manufactured by using the method for manufacturing a support for a planographic printing plate according to any one of the first to fifth aspects of the present invention, a planographic printing plate manufacturing step of manufacturing a planographic printing plate by forming at least a plate making layer on the roughened support for a planographic printing plate, a printing step of performing desired printing by using the manufactured planographic printing plate, a recovery step of recovering the used planographic printing plate left in the printing step, and a recycle step of recycling the recovered, used planographic printing plate into a recycling material used in the preparation step of the method for manufacturing a support for a planographic printing plate according to any one of the first to fifth aspects of the present invention.

The plate making layer is any of a photosensitive, thermosensitve, and photopolymerizable layer.

In the method for recycling a planographic printing plate according to the present invention, since the manufacturing process can be carried out in a closed recycle flow in which 100% fresh metal ingot is used to manufacture planographic printing plates only for the first time and the largest possible proportion of used planographic printing plates roughened by hydrochloric acid-based electrolysis is used as the recycled metal ingot from the second time, the amount of CO₂ produced when planographic printing plates are manufactured can be greatly reduced.

In the method for recycling a planographic printing plate according to the present invention, the recycling material preferably includes cut pieces and other leftovers from a planographic printing plate left in a course of the manufacture in the planographic printing plate manufacturing step as well as the planographic printing plates having been used in printing.

As a result, a completely closed recycle flow for reusing aluminum scraps produced in the planographic printing plate-related industry can be established, whereby the amount of produced CO₂ can be further reduced.

According to the present invention, the amount of produced CO₂, which contributes to the global warming, can be greatly reduced.

### BRIEF DESCRIPTION OF THE DRAWINGS

FIG. 1 is a descriptive diagram describing the flow of a closed-loop recycle provided by a method for recycling a planographic printing plate;

FIG. 2 is a descriptive diagram showing steps of manufacturing a planographic printing plate from an aluminum plate;

FIG. 3 is a cross-sectional view showing an exemplary recycled metal ingot manufacturing apparatus for manufacturing a recycled metal ingot from used planographic printing plates;

FIG. 4 is a flow diagram showing outline of a method for manufacturing a support for a planographic printing plate according to the present invention; and

FIG. 5 is a flow diagram showing outline of a method for recycling a planographic printing plate according to the present invention.

### DETAILED DESCRIPTION OF THE PREFERRED EMBODIMENTS

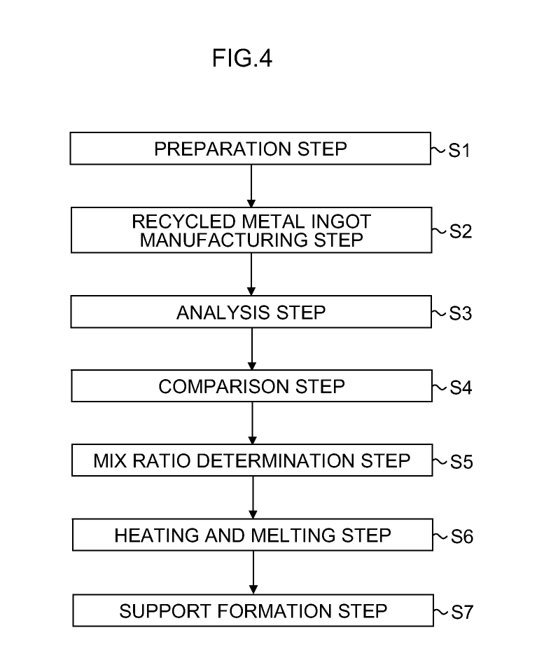

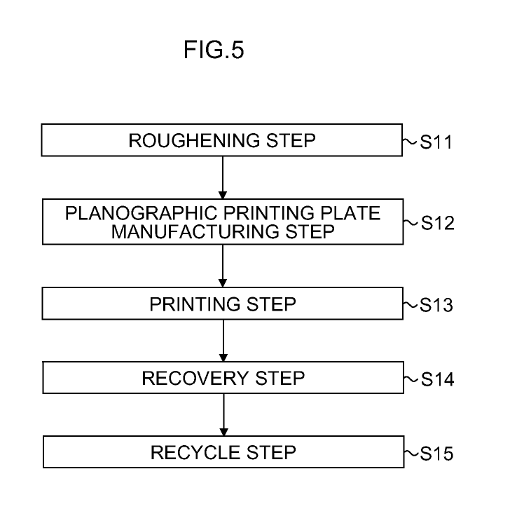

Preferred embodiments of a method for manufacturing a support for a planographic printing plate and a method for recycling a planographic printing plate according to the present invention will be described below in detail. Outlines of the methods are shown in flow diagrams of FIGS. 4 and 5.

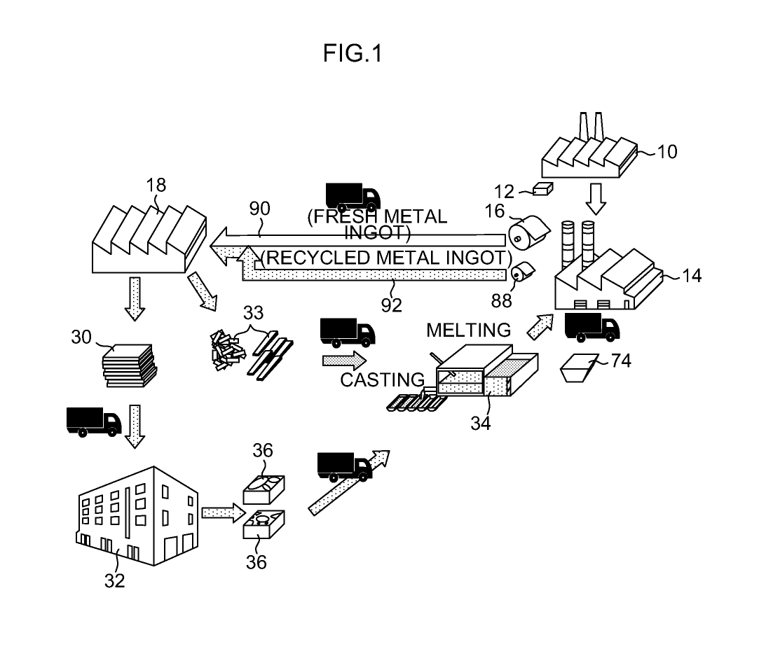

FIG. 1 is a descriptive diagram describing the flow of a closed-loop recycle provided by a method for recycling a planographic printing plate according to the present invention. The following description will be made with reference to a planographic printing plate with a photosensitive plate making layer. A support for the planographic printing plate according to the present invention is a component of the closed-loop recycle.

As shown in FIG. 1, an aluminum refinery 10 manufactures a fresh aluminum ingot 12 from bauxite. The aluminum purity of the fresh aluminum ingot 12 is preferably 99.7% or higher.

The fresh aluminum ingot 12 is then melted in a pre-rolling melting furnace in an aluminum rolling mill 14 into a molten metal, followed by hot rolling and cold rolling. The pre-rolling melting furnace can be a known one in the art. An aluminum plate 16 (a support for planographic printing plate) made of the 100% fresh metal ingot is thus manufactured. The hot rolling start temperature preferably ranges from 350 to 500° C. An intermediate annealing may be carried out before or after the hot rolling or in the course thereof, but intermediate annealing is preferably omitted from the viewpoint of suppressing CO₂ production. The thickness of the aluminum plate produced by the rolling processes preferably ranges from 0.1 to 0.5 mm. After the rolling processes, the flatness of the aluminum plate may be improved by using a roller leveler, a tension leveler, or any other suitable leveler.

Thereafter, the aluminum plate 16 having undergone the rolling and other processes is wound into an aluminum coil and delivered to a planographic printing plate manufacturing factory 18.

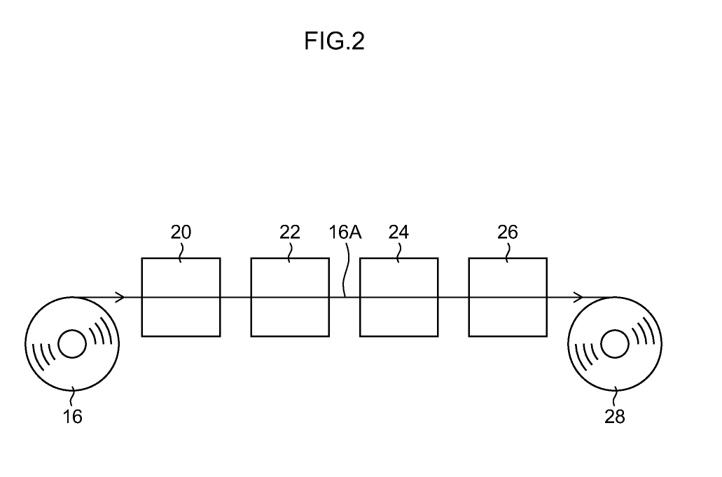

In the planographic printing plate manufacturing factory 18, the aluminum plate 16 undergoes the steps shown in FIG. 2, and a strip-shaped raw plate from which planographic printing plates are formed is manufactured. That is, first, in a roughening step 20 (S11 in FIG. 5), the aluminum plate 16 is roughened by hydrochloric acid-based electrolysis so that the aluminum plate 16 is grained. In this case, it is further preferable that an anodizing step 22 is carried out after the roughening step 20 to form an anodized film on the aluminum plate 16. A roughened support for a planographic printing plate 16A is thus manufactured.

The hydrochloric acid-based electrolytic roughening is carried out by conducting an AC current as an electrolytic current to carry out etching in an aqueous hydrochloric acid solution. The hydrochloric acid concentration of the aqueous hydrochloric acid solution preferably ranges from 3 to 150 g/l, more preferably from 5 to 50 g/l. The aqueous hydrochloric acid solution is particularly preferably obtained by adding aluminum chloride or any other suitable aluminum salt to diluted hydrochloric acid containing 2 to 15 g/l of hydrochloric acid so that the aluminum ion concentration is adjusted to a value ranging from 2 to 7 g/l. The temperature of the aqueous hydrochloric acid solution preferably ranges from 20 to 50° C. The frequency of the AC electrolytic current is preferably set at a value ranging from 0.1 to 100 Hz, more preferably from 10 to 60 Hz. The amount of dissolved aluminum in an electrolysis tank is preferably 50 g/l or smaller, more preferably ranges from 2 to 20 g/l. The current density preferably ranges from 5 to 100 A/dm², more preferably from 10 to 80 A/dm².

The amount of electricity applied in the electrolytic roughening preferably ranges from 20 to 500 C/dm². Among AC currents having various waveforms that can be used as the AC current described above, such as a sinusoidal current, a rectangular current, a trapezoidal current, and a triangular current, a rectangular current and a trapezoidal current are more preferable, and a trapezoidal current is particularly preferable.

In the hydrochloric acid-based electrolytic roughening described above, the aluminum purity and the trace metal contents of the aluminum plate 16 affect the uniformity of pits produced when the aluminum plate is roughened by the electrochemical roughening and hence affect resistance to printing and dirt and stability in light exposure. The aluminum purity and the trace metal contents are therefore preferably within the following ranges. It is noted that the aluminum purity and the trace metal contents shown in the following sections are applied to the aluminum plate 16 made of the 100% fresh metal ingot and an aluminum plate 88 containing a recycling material, which will be described later.

That is, the aluminum purity of the aluminum plate is preferably 99.0% or higher, more preferably 99.5% or higher. When the purity of the aluminum plate is lower than 99.0% and contains a lot of impurities, which are not preferable in the roughening, breaking and other problems tend to occur during the rolling processes.

Among the trace metals contained in the aluminum plate 16, the Si content is preferably 0.50% by mass or lower, more preferably ranges from 0.05 to 0.50% by mass, further more preferably from 0.05 to 0.25% by mass, particularly preferably from 0.06 to 0.15% by mass.

The Cu content is preferably 0.30% by mass or lower, more preferably ranges from 0.010 to 0.30% by mass, further more preferably from 0.02 to 0.15% by mass, particularly preferably from 0.040 to 0.09% by mass.

The Fe content is preferably 0.7% by mass or lower, more preferably ranges from 0.15 to 0.7% by mass, further more preferably from 0.15 to 0.4% by mass, particularly preferably from 0.20 to 0.40% by mass.

The Mn content is preferably 0.5% by mass or lower, more preferably ranges from 0.002 to 0.15% by mass, further more preferably from 0.003 to 0.02% by mass, particularly preferably from 0.004 to 0.01% by mass.

As other trace metals, the Mg content is preferably 1.5% by mass or lower, more preferably ranges from 0.001 to 1.5% by mass, further more preferably from 0.001 to 0.60% by mass, particularly preferably from 0.001 to 0.40% by mass.

The Zn content is preferably 0.25% by mass or lower, more preferably ranges from 0.001 to 0.25% by mass, further more preferably from 0.001 to 0.10% by mass, particularly preferably from 0.010 to 0.03% by mass.

The Ti content is preferably 0.10% by mass or lower, more preferably ranges from 0.001 to 0.10% by mass, further more preferably from 0.001 to 0.05% by mass, particularly preferably from 0.003 to 0.03% by mass.

The Cr content is preferably 0.10% by mass or lower, more preferably ranges from 0.001 to 0.10% by mass, further more preferably from 0.001 to 0.02% by mass, particularly preferably from 0.002 to 0.02% by mass.

Smuts and intermetallic compounds are present on the aluminum plate 16 having been roughened by the hydrochloric acid-based electrolysis described above. It is therefore preferable to perform an alkali treatment using an alkali solution having a pH of 10 or higher and a temperature ranging from 25 to 80° C. and then perform a cleaning treatment using an acidic solution primarily made of sulfuric acid and having a temperature ranging from 20 to 80° C.

Thereafter, a photosensitive layer application liquid is applied onto the roughened surface of the roughened support for a planographic printing plate 16A in a plate making layer forming step 24, and the photosensitive layer is dried in a drying step 26. Further, a mat layer can also be applied onto the photosensitive layer. A strip-shaped raw plate 28, from which planographic printing plates are formed, is thus manufactured (S12 in FIG. 5). In the following processing step, a striped-shaped interleaf is overlaid on the strip-shaped raw plate 28, and the assembly is cut into rectangular sheets having predetermined dimensions. Planographic printing plates 30 with the interleaves (see FIG. 1) are thus manufactured. A plurality of the thus manufactured sheet-shaped planographic printing plates 30 with the interleaves are stacked, packed, and delivered to a printing company 32. Since the interleaf is inserted between the planographic printing plates 30 when they are stacked, the surface of the photosensitive layer of each of the planographic printing plates 30 will not be scratched.

In the step of processing the strip-shaped raw plate 28, leftovers 33, such as cut pieces, are produced from the strip-shaped raw plate 28. The produced leftovers 33 are recovered as a recycling material in the planographic printing plate manufacturing factory 18 and delivered to a downstream recycling factory 34 where the leftovers 33 undergo a recycling process, as shown in FIG. 1.

On the other hand, the planographic printing plates 30 having been delivered to the printing company 32 undergo image exposure and development, are then attached to a printing apparatus, and are used in printing (S13 in FIG. 5). Used planographic printing plates 36 having been used in printing are recovered (S14 in FIGS. 5 and S1 in FIG. 4) as a recycling material in the printing company 32 and delivered to the downstream recycling factory 34 where the used planographic printing plates 36 undergo a recycling process (S15 in FIG. 5).

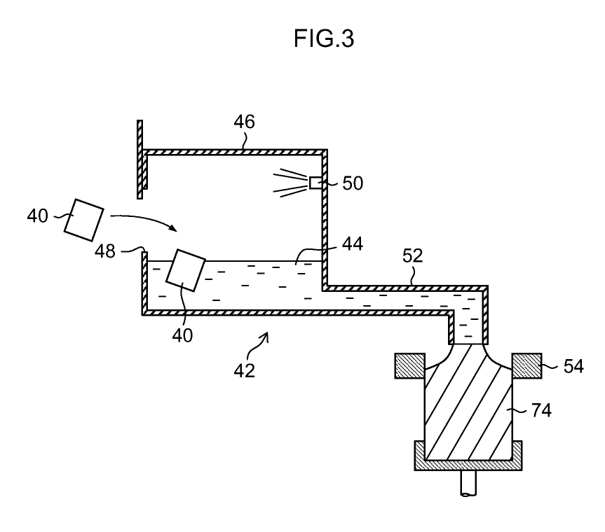

FIG. 3 shows an exemplary recycled metal ingot manufacturing apparatus 38 for manufacturing a recycled metal ingot. In the recycled metal ingot 1 manufacturing apparatus 38, leftovers 33 produced in the planographic printing plate manufacturing factory 18 and the used planographic printing plates 36 produced in the printing company 32, which are a recycling material, undergo a recycling process (S15 in FIG. 5 and S2 in FIG. 4). In the following description, the leftovers 33 and the used planographic printing plates 36 are collectively referred to as a recycling material 40.

As shown in FIG. 3, the recycling material 40 is melted in a melting furnace 42 at a temperature ranging from 680 to 750° C. into a molten metal 44.

The melting furnace 42 has an upper blocking ceiling wall 46 and an opening 48 formed through one side wall, and the recycling material 40 is inputted through the opening 48. A burner 50 is provided on the other side wall facing the input opening 48 and heats and melts the recycling material 40 having been inputted.

The molten metal 44, which is the recycling material 40 having been melted (S2 in FIG. 4) in the melting furnace 42, then flows through a conduit 52 into a trapezoidal, water-cooled or air-cooled die 54, and is molded (S2 in FIG. 4) into a trapezoidal recycled metal ingot 74, each having a weight ranging from 10 to 1200 kg.

In the present invention, used planographic printing plates roughened by hydrochloric acid-based electrolysis are used as the recycling material. It is therefore necessary to select used planographic printing plates electrolyzed by hydrochloric acid for use in the present invention. To this end, it is preferable to check in advance with a planographic printing plate manufacturing company and see if planographic printing plates in question are those electrolyzed by hydrochloric acid or use only planographic printing plates having been confirmed by an electron microscope or any other suitable instrument to have a roughened surface specific to hydrochloric acid-based electrolysis. Further, when a variety of roughening methods are used, it is also preferable to mark planographic printing plates so that what types of roughening are used for the respective planographic printing plates. In this case, the planographic printing plates stored in a recovery hopper equipped with a marking detector are dropped onto a conveyer in accordance with the marking types and sorted in recovery boxes.

As described above, in the recycled metal ingot manufacturing process in which the recycled metal ingot 74 is manufactured from the recycling material 40, the recycling g material 40 is melted in the melting furnace 42 at a melting temperature ranging from 680 to 750° C., whereby the melting speed in the melting furnace 42 is fast, and hence the tact time required to obtain the recycled metal ingot 74 can be shortened. As a result, since the period during which the molten metal 44 comes into contact with air in the recycled metal ingot manufacturing process is shortened, the amount of oxidized substances (aluminum oxides) produced in the manufacturing process is reduced and the yield of the recycled metal ingot increases. Therefore, the amount of CO₂ produced when 1 kg of recycled metal ingot is manufactured can be reduced. That is, setting the temperature at 680° C. or higher allows the melting period to be shorter than that when the temperature is lower than 680° C., and setting the temperature at 750° C. or lower allows the yield to be higher than that when the temperature is higher than 750° C.

Further, in the recycled metal ingot manufacturing process, the used planographic printing plates 30 roughened by hydrochloric acid-based electrolysis is melted in the melting furnace 42 faster than planographic printing plates roughened by mechanical roughening or nitric acid-based electrolysis, whereby the tact time required to obtain a recycled metal ingot can be shortened. As a result, the yield of the recycled metal ingot increases from the same reason as that described in association with the melting temperature, whereby the amount of CO₂ produced when 1 kg of recycled metal ingot is manufactured can be reduced.

Returning back to FIG. 1, the recycled metal ingot 74 manufactured in the recycling factory 34 is recycled in the aluminum rolling mill 14. In the aluminum rolling mill 14, the recycled metal ingot 74 manufactured in the recycling factory 34 is analyzed (S3 in FIG. 4) in terms of the aluminum purity and the contents of trace metals (Si, Fe, Cu, and Mn, for example). The recycled metal ingot 74 may alternatively be analyzed in the recycling factory 34, and the recycled metal ingot 74 accompanied with the analyzed data may be delivered to the aluminum rolling mill 14. The trace metals to be analyzed more preferably include Mg, Zn, Ti, and Cr as well as Si, Fe, Cu, and Mn.

Thereafter, the analyzed values are compared with a desired aluminum purity and desired trace metal contents of a predetermined planographic printing plate, and the difference therebetween is calculated (S4 in FIG. 4). Based on the calculated difference, the mix ratio of a fresh metal ingot having a fixed aluminum purity and fixed trace metal contents and a trace metal master alloy having fixed trace metal contents to the recycled metal ingot is determined (S5 in FIG. 4). That is, since it is possible to know the largest possible mix proportion of the recycled metal ingot for achieving the desired aluminum purity and the desired trace metal contents of the predetermined planographic printing plate, the mix proportion of the recycled metal ingot can be maximized. When the aluminum purity of the fresh metal ingot and the trace metal contents of the trace metal master alloy are not known, analysis similar to that carried out for the recycled metal ingot is carried out.

Thereafter, based on the thus determined mix ratio, the recycled metal ingot, the fresh metal ingot, and the trace metal master alloy are inputted into the pre-rolling melting furnace, heated, and melted into molten aluminum (S6 in FIG. 4).

When the recycled metal ingot 74 inputted into the pre-rolling melting furnace has a spherical shape, the load is concentrated at a single point on the surface of the bottom wall of the pre-rolling melting furnace. In this case, the surface of the bottom wall is likely damaged unless the weight of the recycled metal ingot 74 is smaller than 800 kg. Since the material of a typical melting furnace contains Si, the surface of the bottom wall damaged when the recycled metal ingot 74 is inputted releases Si through the damaged portion, and not only does the dissolved Si contaminate the recycled metal ingot but also the bottom wall of the furnace may be broken in the worst case. Further, the spherical recycled metal ingots 74 are inevitably laid flat, resulting in an increased storage space.

In contrast, when the recycled metal ingot 74 has a trapezoidal shape and is inputted into the pre-rolling melting furnace, the load, which is a surface load, is distributed over the surface of the bottom wall. In this case, the recycled metal ingot 74 metal will not damage or break the surface of the bottom wall even when the recycled metal ingot weighs up to 1200 kg. As a result, the recycled metal ingot 74 will not be contaminated with Si, and the recycled metal ingot 74 can be more efficiently inputted into the pre-rolling melting furnace, whereby the work efficiency in the recycled metal ingot manufacturing process is improved. Further, since the trapezoidal recycled metal ingot 74 allows stacked storage, the storage space can be reduced.

In a method for recycling a planographic printing plate according to the present invention, a 100% fresh metal ingot route 90 in which the aluminum plate 16, which is 100% made of a fresh metal ingot, is delivered from the aluminum rolling mill 14 to the planographic printing plate manufacturing factory 18 is used only for the first time (S7 in FIG. 4), and a recycle route 92 in which the aluminum plate 88 containing a recycling material is delivered from the aluminum rolling mill 14 to the planographic printing plate manufacturing factory 18 is used from the second time (S7 in FIG. 4).

The routes 90 and 92 can establish a completely closed recycle flow for reusing aluminum scraps produced in the planographic printing plate industry. As a result, the amount of produced CO₂ can be reduced by approximately 75% as compared to a case where only the fresh aluminum ingot 12 is used to manufacture a planographic printing plate.

### EXAMPLES

Examples of the present invention will be described below, but the present invention is not limited thereto.

### Example A

In Example A, the amounts of CO₂ produced in an aluminum refining step, a recycled metal ingot manufacturing step, an aluminum rolling step, and a planographic printing plate manufacturing step were studied in the following two cases: a case where 50 tons of planographic printing plate (PS plate) was manufactured in accordance with the present invention and a case where 50 tons of planographic printing plate (PS plate) was manufactured by using 100% fresh metal ingot as in related art.

Table 1 shows the experimental results in Example A. In Experiments 1 to 3, different aluminum raw materials were used, as shown in Table 1, but the steps from the aluminum refining step to the PS plate manufacturing step were carried out in the same condition.

TABLE 1

| | Aluminum raw material (t) | | | Amount of produced CO₂ (t) | | | | |
|---|---|---|---|---|---|---|---|---|
| | Fresh | Recycled metal | Recycled metal | Aluminum | Recycled metal | | PS plate | |
| Experiment | metal | ingot (electrolyzed by | ingot (electrolyzed | refining | ingot | Rolling | manufacturing | |
| No. | ingot | hydrochloric acid) | by nitric acid) | step | manufacturing step | step | step | Total |
| Experiment 1 | 2.5 | 47.5 | — | 23 | 16 | 38 | 60 | 137 |
| Experiment 2 | 2.5 | — | 47.5 | 23 | 19 | 38 | 60 | 140 |
| Experiment 3 | 50.0 | — | — | 461 | 0 | 38 | 60 | 559 |

### (Remarks)

The amount of CO₂ produced in the recycled metal ingot manufacturing step was determined from the energy inputted to melt each electrolyzed recycling material and the yield. The amounts of CO₂ produced in the aluminum refining step and the rolling step were obtained by referring to data in the JAPAN ALUMINIUM ASSOCIATION website.

As seen from the results shown in Table 1, the amount of CO₂ produced in Experiment 1, in which a planographic printing plate was manufactured in accordance with the present invention, is reduced to approximately one-fourth (75% reduction) the amount of CO₂ produced in Experiment 3, in which 100% fresh metal ingot was used. Experiment 1, in which a recycling material electrolyzed by hydrochloric acid according to the present invention was used as the aluminum raw material, and Experiment 2, in which a recycling material electrolyzed by sulfuric acid was used, do not show such a large difference as that shown in the comparison between Experiments 1 and 3, but still show a difference of 3 tons of CO₂ per 50 tons of planographic printing plate, which is a large difference when summed across the entire planographic printing plate manufacturing industry.

### Example B

In Example B, how much the recycling material melting period, the yield, and the amount of produced CO₂ are affected by the roughening method: hydrochloric acid-based electrolysis, nitric acid-based electrolysis, and mechanical roughening (rotating brush).

The experiments were carried out as follows: One ton of planographic printing plate roughened by each of the methods shown in Table 2 was inputted into ten tons of molten aluminum at 720° C., and the period having elapsed until the planographic printing plate was melted, the yield of the recycled metal ingot, and the amount of CO₂ produced when one ton of recycled metal ingot was manufactured were studied.

Table 2 shows the experimental results in Example B.

TABLE 2

| How used plano- | | Yield of | Amount of CO₂ |
|---|---|---|---|
| graphic printing | Melting | recycled | produced when one ton |
| plate was | period | metal | of recycled metal ingot |
| roughened? | (min) | ingot (%) | was manufactured (t) |
| Hydrochloric acid- | 30 | 96.3 | 0.33 |
| based electrolysis | | | |
| Nitric acid-based | 36 | 94.2 | 0.39 |
| electrolysis | | | |
| Mechanical | 37 | 92.0 | 0.40 |
| roughening | | | |

As seen from Table 2, since a planographic printing plate roughened by the hydrochloric acid-based electrolysis is characterized in that the melting period and hence the tact time required to produce the recycled metal ingot are shorter than those for planographic printing plates roughened by the nitric acid-based electrolysis and the mechanical method, the amount of oxidized substances (aluminum oxides) produced when aluminum is combined with oxygen in air is smaller. As a result, the yield of the recycled metal ingot is 96.3%, which is the highest value in Table 2, and the amount of CO₂ produced when one ton of recycled metal ingot was manufactured is 0.33 tons, which is the smallest value.

### Example C

In Example C, the relationship of the melting temperature at which a recycling material (used planographic printing plate) was melted in the melting furnace with the melting period and the yield of the recycled metal ingot was studied.

The experiments were carried out as follows: One ton of used planographic printing plate having undergone the hydrochloric acid-based electrolysis was inputted into ten tons of molten aluminum at melting temperatures shown in Table 3, and the melting period and the yield of the recycled metal ingot were studied.

Table 3 shows the experimental results in Example C.

TABLE 3

Melting temperature

| | 650° C. | 680° C. | 750° C. | 780° C. |
|---|---|---|---|---|
| Melting period | 70 min | 35 min | 30 min | 25 min |
| Yield of recycled | 94.5% | 96.0% | 95.5% | 92.0% |
| metal ingot | | | | |

As seen from Table 3, when the melting temperature ranges from 680 to 750° C., the melting period ranges from 30 to 35 minutes, which is approximately one-half of 70 minutes required when the melting temperature is 650° C. As a result, the tact time and hence the amount of oxidized substances (aluminum oxides) decrease. The yield of the recycled metal ingot at a melting temperature ranging from 680 to 750° C. ranges from 95.5 to 96.0%, which is higher than 94.54% obtained at 650° C.

On the other hand, when the melting temperature was 780° C., which is the highest value, the melting period was further shortened to 25 minutes, but the yield of the recycled metal ingot was 92.0%, which is the worst result. The reason for this is considered as follows: The high melting temperature of 780° C. encourages the recycling material to react with oxygen in air in an oxidation reaction and hence the production of oxidized substances (aluminum oxides) further proceeds.

It is therefore preferable that the melting temperature in the melting furnace when a recycled metal ingot is manufactured is set within a range from 680 to 750° C. The thus set melting temperature increases the yield and hence reduces the amount of CO₂ produced in the recycled metal ingot manufacturing step.

### Example D

In Example D, how the shape and weight of a recycled metal ingot affect the storage space and the surface of the bottom wall of the melting furnace was studied.

In the experiments, how badly the floor of the furnace was damaged when the recycled metal ingot was inputted into the melting furnace and the storage space necessary to store ten tons of recycled metal ingot were studied.

To study how badly the floor of the furnace was damaged, a forklift was used to input recycled metal ingots having different shapes and weights into ten tons of molten aluminum, and how badly the inputted recycled metal ingots affected the floor of the furnace made of brick was studied. The storage space was studied when the recycled metal ingots were carefully stored so that they can be stored in the smallest possible space.

The experimental results show that slight damage was found at the bottom of the furnace when a trapezoidal recycled metal ingot that weighs 3000 kg was inputted, but that no damage was found when a trapezoidal recycled metal ingot that weighs 1200 kg was inputted. The space necessary to store 10 tons of recycled metal ingot each having a weight of 10 kg and the space necessary to store 10 tons of recycled metal ingot each having a weight of 1200 kg range from 4 to 6 m² because the recycled metal ingots were capable of being stacked.

On the other hand, clear damage (indent and crack) was found at the bottom of the furnace when a spherical recycled metal ingot that weighed 500 kg was inputted into the melting furnace, but that no damage was found when a spherical recycled metal ingot that weighed 10 kg was inputted. The space necessary to store 10 tons of recycled metal ingot, each having a weight of 10 kg, and the space necessary to store 10 tons of recycled metal ingot, each having a weight of 500 kg, range from 40 to 50 m² because the recycled metal ingots were laid flat.

As described above, a recycled metal ingot preferably has a trapezoidal shape and weighs from 10 to 1200 kg.

The shape and weight of a recycled metal ingot do not directly relate to the amount of produced CO₂. However, breakage of the bottom of the furnace will cause contamination of molten aluminum with an Si component contained in brick typically used as the material of the bottom the furnace, sometimes resulting in a situation where the mix ratio of the recycled metal ingot to the fresh metal ingot needs to be reduced. Since decrease in the mix proportion of the recycled metal ingot increases the amount of CO₂ produced when a support for a planographic printing plate is manufactured, the shape and weight of the recycled metal ingot indirectly affect the amount of produced CO₂.

### Example E

In Example E, the difference in the amount of produced CO₂ between the following two cases was studied when used planographic printing plates formed of various hydrochloric acid electrolyzed materials manufactured in different lots were used as a recycling material: a case where 50 tons of planographic printing plate was manufactured by converting the recycling material temporarily into a recycled metal ingot in the melting furnace, determining the mix ratio of the recycled metal ingot to a fresh metal ingot and a trace metal master alloy in such a way that the proportion of the recycled metal ingot is maximized, and inputting the recycled metal ingo, the fresh metal ingot, and the trace metal master alloy into the pre-rolling melting furnace, as in the present invention (Examples), and a case where 50 tons of planographic printing plate was manufactured by directly inputting the recycling material along with a fresh metal ingot and a trace metal master alloy into the pre-rolling melting furnace, as in related art (Comparative Example 1).

In addition to the above, the amount of CO₂ produced when planographic printing plates were manufactured by using 100% fresh metal ingot (Comparative Example 2) was studied.

The amount of produced CO₂ was studied in each of the aluminum refining step, the recycled metal ingot manufacturing step, the rolling step, and the planographic printing plate manufacturing step, and the amounts of CO₂ produced in the steps described above were summed and compared.

In the Example, the trace metal contents required for an aluminum plate used to manufacture a desired planographic printing plate were compared with the analyzed trace metal contents of the recycled metal ingot and the fresh metal ingot. Based on the comparison result, the following proportions were calculated in advance: the largest possible mix proportion of the recycled metal ingot was 41 tons, the fresh metal ingot (remainder) was 9 tons, and the trace metal master alloy (aluminum-copper alloy) was 4 kg. The recycled metal ingot, the fresh metal ingot, and the trace metal master alloy were inputted into the pre-rolling melting furnace in such a way that the mix ratio described above was satisfied and melted therein. Thereafter, the resultant molten aluminum was rolled into an aluminum plate, and planographic printing plates were manufactured by using the aluminum plate as a support for the planographic printing plate.

In Comparative Example 1, 10 tons of used planographic printing plate formed of various hydrochloric acid electrolyzed materials manufactured in different lots were directly inputted into the pre-rolling melting furnace and melted therein into molten aluminum, and part of the molten aluminum was collected and analyzed in terms of trace metal contents. The result of the analysis showed that the Si content was as low as 0.06%, and hence another 10 tons of used planographic printing plate was additionally inputted into the pre-rolling melting furnace and melted therein. Part of the molten aluminum obtained by the first and second inputting and melting operations, that is, obtained by inputting planographic printing plates multiple times, was collected and analyzed in terms of trace metal contents. The resultant Si content was 0.09%, which could pose a risk of exceeding the Si content of 0.06%, which is required for a desired planographic printing plate, even when a fresh metal ingot was mixed. At the same time, inputting planographic printing plates multiple times could pose another risk of decrease in the yield because the increased melting period could produce a large amount of oxidized substances (aluminum oxides). Based on the judgment described above, a third input of used planographic printing plates was not carried out, but 30 tons of fresh metal ingot and 20 kg of trace metal master alloy (aluminum-copper alloy) were inputted into the pre-rolling melting furnace and melted therein. Thereafter, the molten aluminum was rolled into an aluminum plate, and planographic printing plates were manufactured by using the aluminum plate as a support for the planographic printing plate.

In Comparative Example 2, the method used in Example A to manufacture planographic printing plates by using 100% fresh metal ingot was employed.

Table 4 shows the experimental results in Example E.

TABLE 4

| | Aluminum raw material (t) | | Amount of produced CO₂ (t) | | | | |
|---|---|---|---|---|---|---|---|
| | | Used planographic printing | | Recycled | | | |
| | Fresh | plates formed of various | Aluminum | metal ingot | | PS plate | |
| Experiment | metal | hydrochloric acid | refining | manufacturing | Rolling | manufacturing | |
| No. | ingot | electrolyzed materials | step | step | step | step | Total |
| Example | 9 | 41 | 83 | 13.5 | 38 | 60 | 195 |
| Comparative | 30 | 20 | 277 | 0 | 38 | 60 | 375 |
| Example 1 | | | | | | | |
| Comparative | 50 | 0 | 461 | 0 | 38 | 60 | 559 |
| Example 2 | | | | | | | |

As seen from Table 4, since the Example conducted in accordance with the present invention include the step of manufacturing a recycled metal ingot from a recycling material, CO₂ is produced in the recycled metal ingot manufacturing step, unlike Comparative Examples 1 and 2. However, a large number of recycled metal ingots having uniform trace metal contents can be manufactured by melting used planographic printing plates in the melting furnace temporarily into a recycled metal ingot even when various electrolyzed materials manufactured in different lots are present. As a result, since the recycled metal ingots manufactured in the same melting furnace have the same trace metal contents, analyzing the trace metal contents of the molten aluminum or one of the recycled metal ingots allows the maximum mix ratio of the recycled metal ingot to the fresh metal ingot to be determined with high precision. It is therefore possible to manufacture a support for a planographic printing plate having desired trace metal contents even when the mix proportion of used planographic printing plates is maximized.

When used planographic printing plates formed of various electrolyzed materials manufactured in different lots are directly inputted into the pre-rolling melting furnace, as in Comparative Example 1, the trace metal contents vary depending on the ratio among the lots to be inputted. In this case, it is necessary to analyze the trace metal contents of the molten aluminum and increase the mix proportion of used planographic printing plates in a cut-and-try manner whenever the input operation is carried out. To analyze the trace metals with precision before used planographic printing plates are inputted into the pre-rolling melting furnace, which is the case of the present invention, it is necessary to analyze each used planographic printing plate, which is practically impossible.

As described above, converting a recycling material, such as used planographic printing plates, temporarily into a recycled metal ingot is an important step to reduce the amount of produced CO₂.

### Example F

In Example F, one ton of used planographic printing plate electrolyzed by hydrochloric acid was melted in the melting furnace and kept at 700° C., and the relationship between the period during which the temperature was kept and the yield was studied.

Table 5 shows the experimental results in Example F.

TABLE 5

Period during which temperature was kept

| | 10 min | 60 min | 180 min | 360 min |
|---|---|---|---|---|
| Yield | 96.2% | 95.1% | 94.4% | 93.2% |

As seen from Table 5, when the molten aluminum was exposed to a high-temperature environment for a long time after the melting step, the yield decreases. It is therefore preferable that after used planographic printing plates are melted in the melting furnace, the molten material is immediately poured into a water-cooled or air-cooled die to form a recycled metal ingot.

What is claimed is:

1. A method for manufacturing a support for a planographic printing plate, the method comprising:
a preparation step of preparing used planographic printing plates, as a recycling material, roughened by hydrochloric acid-based electrolysis;
a recycled metal ingot manufacturing step of manufacturing a recycled metal ingot by melting the recycling material in a melting furnace into molten metal and molding the molten metal into a recycled metal ingot having a predetermined shape and weight;
an analysis step of analyzing an aluminum purity and trace metal contents of the recycled metal ingot;
a comparison step of comparing the analyzed values with a desired aluminum purity and desired trace metal contents of a predetermined planographic printing plate and calculating the difference;
a mix ratio determination step of determining a mix ratio, based on the calculated difference, of a fresh metal ingot having a fixed aluminum purity and fixed trace metal contents and a trace metal master alloy having fixed trace metal contents to the recycled metal ingot;
a heating and melting step of inputting the recycled metal ingot, the fresh metal ingot, and the trace metal master alloy into a pre-rolling melting furnace in accordance with the determined mix ratio and heating and melting the recycled metal ingot, the fresh metal ingot, and the trace metal master alloy into molten aluminum; and
a support formation step of forming a support for a planographic printing plate, which is a strip-shaped aluminum plate, from the resultant molten aluminum in a rolling process.

2. The method for manufacturing a support for a planographic printing plate according to claim 1,
wherein the recycling material is melted at a temperature within a range from 680 to 750° C. in the recycled metal ingot manufacturing step.

3. The method for manufacturing a support for a planographic printing plate according to claim 1,
wherein the aluminum purity of the molten aluminum before the rolling process is 99.0% or higher.

4. The method for manufacturing a support for a planographic printing plate according to claim 2,
wherein the aluminum purity of the molten aluminum before the rolling process is 99.0% or higher.

5. The method for manufacturing a support for a planographic printing plate according to of claim 1,
wherein the trace metals to be analyzed include at least Si, Fe, Cu, and Mn.

6. The method for manufacturing a support for a planographic printing plate according to claim 4,
wherein the trace metals to be analyzed include at least Si, Fe, Cu, and Mn.

7. The method for manufacturing a support for a planographic printing plate according to claim 1,
wherein the recycled metal ingot is shaped into a trapezoidal block and weighs from 10 to 1200 kg per block, and
the recycled metal ingot is inputted into the melting furnace in such a way that a bottom surface of the trapezoidal block is placed on the floor of the melting furnace.

8. The method for manufacturing a support for a planographic printing plate according to claim 6,
wherein the recycled metal ingot is shaped into a trapezoidal block and weighs from 10 to 1200 kg per block, and
the recycled metal ingot is inputted into the pre-rolling melting furnace in such a way that a bottom surface of the trapezoidal block is placed on the floor of the pre-rolling melting furnace.

9. A method for recycling a planographic printing plate, the method comprising:
a roughening step of performing hydrochloric acid-based electrolytic roughening on at least one side of the support for a planographic printing plate manufactured by using the method for manufacturing a support for a planographic printing plate according to claim 1;
a planographic printing plate manufacturing step of manufacturing a planographic printing plate by forming at least a plate making layer on the roughened support for a planographic printing plate;
a printing step of performing desired printing by using the manufactured planographic printing plate;
a recovery step of recovering the used planographic printing plate left in the printing step; and
a recycle step of recycling the recovered, used planographic printing plate into a recycling material used in the preparation step of the method for manufacturing a support for a planographic printing plate according to claim 1.

10. The method for recycling a planographic printing plate according to claim 9,
wherein the recycling material includes cut pieces and other leftovers from a planographic printing plate left in a course of the manufacture in the planographic printing plate manufacturing step as well as the planographic printing plates having been used in printing.
